(19) United States
(12) Patent Application Publication
(10) Pub. No.: US 2024/0121736 A1
(43) Pub. Date: Apr. 11, 2024

(54) TERMINAL AND RADIO BASE STATION

(71) Applicant: NTT DOCOMO, INC., Tokyo (JP)

(72) Inventor: Tianyang Min, Tokyo (JP)

(73) Assignee: NTT DOCOMO, INC., Tokyo (JP)

(21) Appl. No.: 18/262,281

(22) PCT Filed: Jan. 21, 2021
(86) PCT No.: PCT/JP2021/002066

§ 371 Date: Jul. 20, 2023

(51) Int. Cl. H04W 56/00

(52) U.S. Cl. CPC H04W 56/0045

(57) ABSTRACT

A terminal acquires a time difference between a transmission timing of a first signal and a reception timing of a second signal. When the time difference exceeds a defined threshold value, the terminal transmits time difference information indicating the time difference to a radio base station.

### TECHNICAL FIELD

The present disclosure relates to a terminal and a radio base station that support propagation delay compensation.

### BACKGROUND ART

3rd Generation Partnership Project (3GPP) specifies 5th generation mobile communication system (5G, also called New Radio (NR) or Next Generation (NG), further, a succeeding system called Beyond 5G, 5G Evolution or 6G is being specified.

In 3GPP Release-17, with regard to support for Industrial Internet of Things (IIoT) and URLLC (Ultra-Reliable and Low Latency Communications), the goal is to realize even higher precision synchronization between a radio base station (gNB) and a terminal (User Equipment, UE) (Non-Patent Literature 1).

In such a case, it is essential to compensate for the propagation delay in the radio link between the UE and the gNB. 3GPP has agreed to study not only propagation delay compensation using Timing Advance (TA) but also RTT based delay compensation using Round-Trip Time (RTT) between UE and gNB (Non-Patent Literature 2).

### CITATION LIST

### Non-Patent Literature

[Non-Patent Literature 1] “Enhanced Industrial Internet of Things (IoT) and ultra-reliable and low latency communication (URLLC) support for NR”, RP-201310, 3GPP TSG RAN Meeting #88e, 3GPP, July 2020

[Non-Patent Literature 2]
“Summary #1 of email discussion [102e-NR-IIOT_URLLC_enh-05]”, R1-2007068, 3GPP TSG RAN WG1 Meeting #102-e, 3GPP, August2020

### SUMMARY OF INVENTION

In the case of RTT-based propagation delay compensation, the timing at which the UE notifies the gNB of the time difference between the measured transmission signal and the received signal is a problem. In addition, in the case of RTT-based propagation delay compensation, the timing of executing propagation delay compensation using RTT becomes a problem.

That is, it is necessary to exchange RTT-related information in cooperation between the UE and the gNB, and without such cooperation, there is a problem that propagation delay compensation based on the RTT is difficult.

Accordingly, the following disclosure has been made in view of such a situation, and it is an object of the present invention to provide a terminal and a radio base station capable of appropriately performing RTT-based propagation delay compensation.

One aspect of the present disclosure is a terminal (UE 200) including a control unit (control unit 240) that acquires a time difference between a transmission timing of a first signal and a reception timing of a second signal, and a transmission unit (time information processing unit 230) that, when the time difference exceeds a defined threshold value, transmits time difference information indicating the time difference to a radio base station.

One aspect of the present disclosure is a radio base station (gNB 100) including a reception unit (time management unit 130) that receives time difference information indicating a first time difference between a transmission timing of a first signal and a reception timing of a second signal at a terminal, a control unit (control unit 140) that, when the time difference information is received, acquires a propagation delay with the terminal based on the first time difference and a second time difference between a reception timing of the first signal and a transmission timing of the second signal.

One aspect of the present disclosure is a terminal (UE 200) including a reception unit (time information processing unit 230) that receives time difference information indicating a first time difference between a reception timing of a first signal and a transmission timing of a second signal in a radio base station, and a control unit (control unit 240) that, when the time difference information is received, acquires a propagation delay with the radio base station based on the first time difference and a second time difference between a transmission timing of the first signal and a reception timing of the second signal.

### BRIEF DESCRIPTION OF DRAWINGS

FIG. 1 is an overall schematic configuration diagram of radio communication system 10.

FIG. 2 is a functional block diagram of the gNB 100.

FIG. 3 is a functional block diagram of the UE 200.

FIG. 4 is a diagram showing an example of the calculation and reporting sequence of the UE Rx-Tx time difference and the gNB Rx-Tx time difference using UL-RS and DL-RS.

FIG. 5 is a diagram showing an example of a schematic operation sequence of RTT based delay compensation by a UE trigger.

FIG. 6 is a diagram showing an example of a schematic operation sequence of RTT based delay compensation by a gNB trigger.

FIG. 7 is a diagram showing an example of a hardware configuration of the gNB 100 and the UE 200.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

### (1) Overall Schematic Configuration of the Radio Communication System

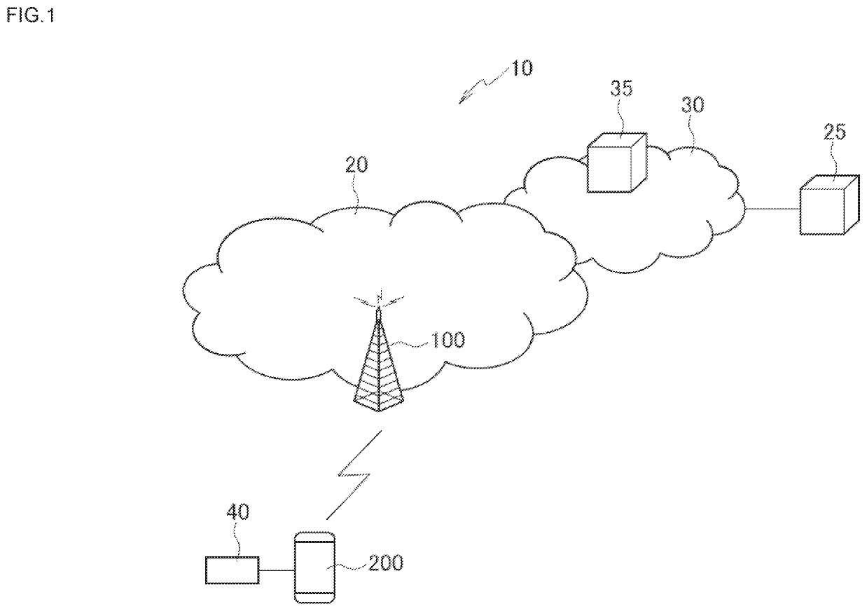

FIG. 1 is an overall schematic configuration diagram of a radio communication system 10 according to this embodiment. radio communication system 10 is a 5 G New Radio (NR) compliant radio communication system and includes a Next Generation-Radio Access Network 20 (User Equipment 200, hereinafter UE 200), NG-RAN 20, and user terminal 200.

The radio communication system 10 may be a radio communication system that follows a scheme called Beyond 5G, 5G Evolution or 6G.

The NG-RAN 20 includes a radio base station 100 (hereinafter, gNB 100). The specific configuration of radio communication system 10 including the number of gNBs and UEs is not limited to the example shown in FIG. 1.

The NG-RAN 20 actually includes a plurality of NG-RAN Nodes, specifically, gNBs (or ng-eNBs), and is connected to the 5 GC 30, which is a core network according to 5G. The NG-RAN 20 and the 5 GC 30 may be expressed simply as a “network”.

5 The GC 30 may be provided with a User Plane Function 35 (hereinafter, UPF 35) that is included in the 5G system architecture and provides user plane functionality. The UPF 35 may be connected via a specific interface to a TSN grandmaster 25 (TSC GM 25) that provides time information used in a Time Sensitive Network (TSN).

The TSC GM 25 can provide highly accurate time information (date and time) to the IoT device 40 connected to the UE 200 via the NG-PAN 20 or the like. The IoT device 40 may be referred to as an end station or the like.

For example, TSN may be used as a network for Industrial Internet of Things (IIoT). The TSN may be configured as a separate network from the NG-RAN 20 and 5 GC 30, i.e., the NR (5G) system, and may be synchronized with the timing of independent clock generation.

The TSN may include networks associated with services that require high synchronization accuracy in a wide service area, such as a smart grid.

The gNB 100 is a radio base station according to NR, and executes radio communication according to the UE 200 and NR. By controlling radio signals transmitted from a plurality of antenna elements, the gNB 100 and the UE 200 can support Massive MIMO that generates a beam with higher directivity, carrier aggregation (CA) that uses a plurality of component carriers (CCs) bundled together, and dual connectivity (DC) that simultaneously communicates between the UE and each of a plurality of NG-RAN nodes.

The IoT device 40 may be a TSN, for example, a communication device (terminal) included in the IIoT, and may be synchronized with timing (time information) in the TSN.

Thus, in the present embodiment, the TSC GM 25 and the IoT device 40 can be connected to the NR (5G) system, providing a mechanism for compensating for the propagation delay between the UE 200 and the gNB 100.

The IoT device 40 connected to the UE 200 can operate in synchronization with TSN time information provided by the TSC GM 25. On the other hand, in a NR (5G) system, a 5G grand master (5G GM) provides time information used in the system. The UPF 35, the gNB 100 and the UE 200 can operate in synchronization with the time information of the 5G GM.

In addition, in order to achieve high synchronization accuracy (For example, less than 1 μs), the propagation delay between the UE 200 and the gNB 100 can be compensated. Specifically, radio communication system 10 can compensate for the propagation delay in the radio section between the UE 200 and the gNB 100 (Specifically, distributed units (DUs)) to which the UE 200 is connected. Propagation delay compensation may be interpreted as adjusting the time information for the NR system or TSN according to the amount of propagation delay in the radio section, so that each of the IoT devices 40 can operate in synchronization with the time information for the TSN. More specifically, it may be interpreted that the propagation delay between the UE 200 and the gNB 100 (radio section) is adjusted to the time information obtained by subtracting the propagation delay from the time information for the TSN.

Alternatively, the propagation delay compensation may be interpreted as adjusting the propagation delay between the UE 200 and the gNB 100 (radio section) to the time information obtained by subtracting the propagation delay from the time information of the 5G GM, and it may be interpreted as allowing the 5G system to act as a TSN bridge and each TSN IoT device to operate in synchronization with the time for TSN if accurate synchronization is maintained within the 5G system.

In radio communication system 10, a mechanism of not only propagation delay compensation using Timing Advance (TA) but also propagation delay compensation using Round-Trip Time (RTT) may be introduced between the UE 200 and the gNB 100.

### (2) Function Block Configuration of Radio Communication System

Next, the functional block configuration of radio communication system 10 will be described. Specifically, the functional block configurations of the gNB 100 and the UE 200 will be described.

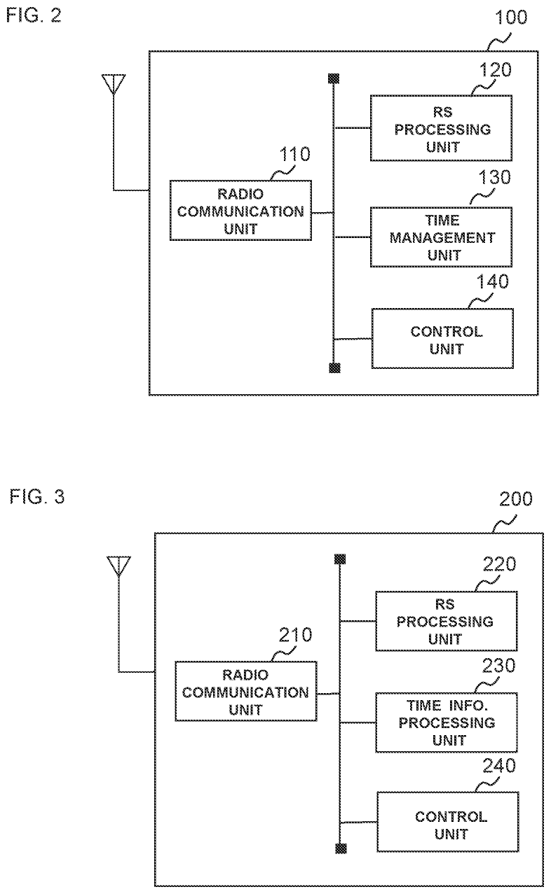

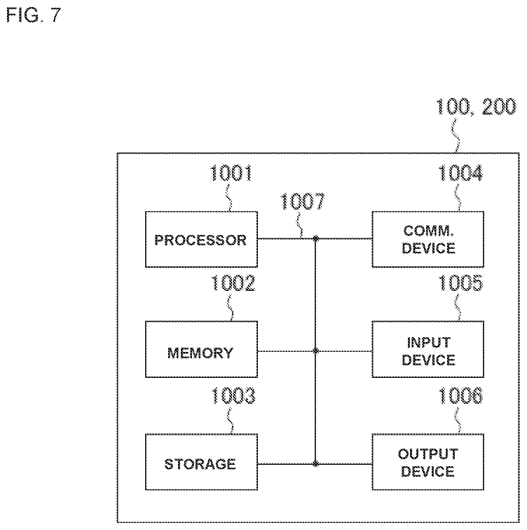

FIG. 2 is a functional block diagram of the gNB 100. FIG. 3 is a functional block diagram of the UE 200. Note that FIG. 2 and FIG. 3 show only the main functional blocks related to the description of the embodiment, and that gNB 100 and UE 200 have other functional blocks (For example, the power supply section, etc.). FIGS. 2 and 3 show functional block configurations of the gNB 100 and the UE 200, and refer to FIG. 7 for a hardware configuration.

### (2.1) gNB 100

As shown in FIG. 2, the gNB 100 includes a radio communication unit 110, a reference signal processing unit 120, a time management unit 130, and a control unit 140.

The radio communication unit 110 transmits and receives a radio signal according to NR. Specifically, the radio communication unit 110 receives an uplink signal (UL signal) in accordance with NR and transmits a downlink signal (DL signal) in accordance with NR. The radio communication unit 110 corresponds to Massive MIMO, CA using a plurality of CCs bundled together, and DC performing simultaneous communication between the UE and each of the two NG-RAN nodes.

The radio communication unit 110 transmits and receives various channels of the physical layer. The channel includes a control channel and a data channel.

The control channel may include a PDCCH (Physical Downlink Control Channel), a PUCCH (Physical Uplink Control Channel), a RACH (Downlink Control Information (DCI) with Random Access Channel, Random Access Radio Network Temporary Identifier (RA-RNTI)), a Physical Broadcast Channel (PBCH), and the like.

The data channels include PDSCH (Physical Downlink Shared Channel) and PUSCH (Physical Uplink Shared Channel). Data may refer to data transmitted over a data channel.

The reference signal processing unit 120 executes processing relating to the reference signal. The reference signal may be interpreted as a known pilot signal between the base station and the terminal. Specifically, the reference signal processing unit 120 executes processing in the DL direction, that is, processing relating to a reference signal (which may be referred to as DL-RS) transmitted by the gNB 100. Further, the reference signal processing unit 120 executes processing relating to the UL direction, that is, the reference signal (which may be referred to as UL-RS) received by the gNB 100.

The DL-RS may include, for example, a Positioning Reference Signal (PRS) for location information, a Tracking Reference Signal (TRS) for tracking, a Demodulation Reference Signal (DMRS), and the like. Note that the DL-RS may include an RS in another DL direction. In the present embodiment, the DL-RS may include an SS that constitutes the Synchronization Signal/Physical Broadcast Channel blocks (SS/PBCH).

The UL-RS may include, for example, a Sounding Reference Signal (SRS), a TRS, a DMRS, and the like. The UL-RS may include an RS in another UL direction. In the present embodiment, the UL-RS may include a PRACH (Physical Random Access Channel).

The time management unit 130 manages time information used in radio communication system 10. Specifically, the time management unit 130 manages the time information of the TSN and the time information of the NR (5G) system.

The time management unit 130 can acquire TSN time information from the TSC GM 25 and provide the acquired time information to the UE 200. The time management unit 130 can acquire the time information of the NR (5G) system from the 5G GM and provide the acquired time information to the UE 200.

The time management unit 130 can receive time difference information indicating a time difference (first time difference) between the transmission timing of the reference signal (first signal) in the UE 200 and the reception timing of another reference signal (second signal) in the UE 200. In the present embodiment, the time management unit 130 may constitute a reception unit.

Specifically, the time management unit 130 can receive information indicating the time difference (UE Rx-Tx time difference) between the transmission timing (transmission time) of UL-RS in the UE 200 and the reception timing (reception time) of DL-RS in the UE 200 from the UE 200.

Note that the time management unit 130 may receive the time difference information periodically, or may receive it non-periodically, for example, when a specific event (event) occurs.

The time management unit 130 can also transmit information indicating the time difference (gNB Rx-Tx time difference) between the reception timing of UL-RS and the transmission timing of DL-RS in the gNB 100 to the UE 200.

The control unit 140 controls each functional block constituting the gNB 100. In particular, in this embodiment, the control unit 140 executes control concerning compensation of propagation delay in the section between the UE 200 and the gNB 100.

Specifically, when the control unit 140 receives the time difference information described above through the time management unit 130, the propagation delay with the UE 200 can be acquired based on the first time difference between the transmission timing of the reference signal (first signal) in the UE 200 and the reception timing of another reference signal (second signal) in the UE 200 and the second time difference between the reception timing of the first signal and the second signal and the transmission timing in the gNB 100.

More specifically, the control unit 140 obtains the propagation delay based on the UE Rx-Tx time difference (first time difference) and the gNB Rx-Tx time difference (second time difference). The control unit 140 may obtain the sum of the UE Rx-Tx time difference and the gNB Rx-Tx time difference. The sum may be interpreted as an RTT.

Also, a predetermined offset value or the like may be added (or subtracted) to the sum of the UE Rx-Tx time difference and the gNB Rx-Tx time difference.

The control unit 140 may calculate the propagation delay between the UE 200 and the gNB 100 by dividing the total value by 2 ((UE Rx-Tx time difference+gnB Rx-Tx time difference)/2). The calculation of the UE Rx-Tx time difference and the gNB Rx-Tx time difference and the measurement points (reference points) may be in accordance with the provisions of Chapters 5.1.30 and 5.2.3 of 3 GPP TS 38.215.

The control unit 140 may perform propagation delay compensation based on the calculated propagation delay between the UE 200 and the gNB 100. Specifically, the control unit 140 may adjust the time information for the NR system or the TSN in accordance with the propagation delay amount of the radio section.

### (2.2) UE 200

As shown in FIG. 3, the UE 200 includes a radio communication unit 210, a reference signal processing unit 220, a time information processing unit 230, and a control unit 240.

The radio communication unit 210 transmits and receives a radio signal according to NR. Specifically, the radio communication unit 210 transmits a UL signal in accordance with NR and receives a DL signal in accordance with NR. The radio communication unit 210 corresponds to Massive MIMO, CA using a plurality of CCs bundled together, and DC performing simultaneous communication between the UE and each of the two NG-RAN nodes.

The radio communication unit 210 transmits and receives various channels of the physical layer. The channel includes a control channel and a data channel.

The reference signal processing unit 220 executes processing relating to the reference signal. Specifically, the reference signal processing unit 220 executes processing relating to the UL direction, that is, the reference signal (UL-RS) transmitted by the UE 200. Further, the reference signal processing unit 120 executes processing relating to the reference signal (DL-RS) received by the UE 200 in the DL direction. Specific reference signals included in the UL-RS and DL-RS transmitted and received by the UE 200 may be as described above.

The time information processing unit 230 executes processing related to time information (5 G GM reference) used in radio communication system 10 and time information for TSN (TSC GM 25 reference).

Specifically, the time information processing unit 230 can provide the time information of the 5G GM reference to the functional blocks constituting the UE 200. The time information processing unit 230 can acquire time information based on the TSC GM 25 from the network and provide the acquired time information to the IoT device 40.

The time information processing unit 230 may transmit time difference information indicating the time difference to the gNB 100 when the time difference between the transmission timing and the reception timing of the predetermined reference signal, specifically, the UE Rx-Tx time difference exceeds the specified threshold. In the present embodiment, the time information processing unit 230 may constitute a transmission unit.

The time information processing unit 230 may receive time difference information indicating a time difference (first time difference) between the reception timing (t2) of the UL-RS (first signal) and the transmission timing (t3) of the DL-RS (second signal) in the gNB 100. In the present embodiment, the time information processing unit 230 may constitute a reception unit.

Specifically, the time information processing unit 230 can receive the time difference information indicating the gNB Rx-Tx time difference.

Note that the time management unit 130 may receive the time difference information periodically, or may receive it non-periodically, for example, when a specific event (event) occurs.

The control unit 240 controls each functional block constituting the UE 200. Specifically, in the present embodiment, the control unit 240 compensates for the propagation delay in the section between the UE 200 and the gNB 100 and controls the time information used in radio communication system 10.

Specifically, the control unit 240 can acquire the time difference (UE Rx-Tx time difference) between the transmission timing (t1) of the UL-RS (first signal) and the reception timing (t4) of the DL-RS (second signal).

When the control unit 240 receives information indicating the gNB Rx-Tx time difference (time difference information), the propagation delay with the gNB 100 can be acquired based on the gNB Rx-Tx time difference and the UE Rx-Tx time difference.

The control unit 240 acquires the propagation delay based on the UE Rx-Tx time difference and the gNB Rx-Tx time difference. Specifically, the control unit 240 may obtain the sum of the UE Rx-Tx time difference and the gNB Rx-Tx time difference. The sum may be interpreted as an RTT.

The control unit 240 may calculate the propagation delay in the section between the UE 200 and the gNB 100 by dividing the total value by 2 ((UE Rx-Tx time difference+gnB Rx-Tx time difference)/2).

The control unit 240 may also perform propagation delay compensation based on the calculated propagation delay between the UE 200 and the gNB 100. Specifically, the control unit 240 may adjust the time information for the NR system or the TSN in accordance with the propagation delay amount of the radio section.

### (3) Operation of Radio Communication System

Next, the operation of radio communication system 10 will be described. Specifically, an operation related to RTT based delay compensation using RTT between the UE 200 and the gNB 100 will be described.

### (3.1) Operation Example 1

First, the operation of calculating and reporting the UE Rx-Tx time difference and the gNB Rx-Tx time difference using UL-RS and DL-RS will be described.

RTT based delay compensation can be performed using UE Rx-Tx time difference and gNB Rx-Tx time difference. The UE Rx-Tx time difference may be reported from UE 200 to gNB 100 according to LPP (Long Term Evolution Positioning Protocol) or Radio Resource Control Layer (RRC) protocols.

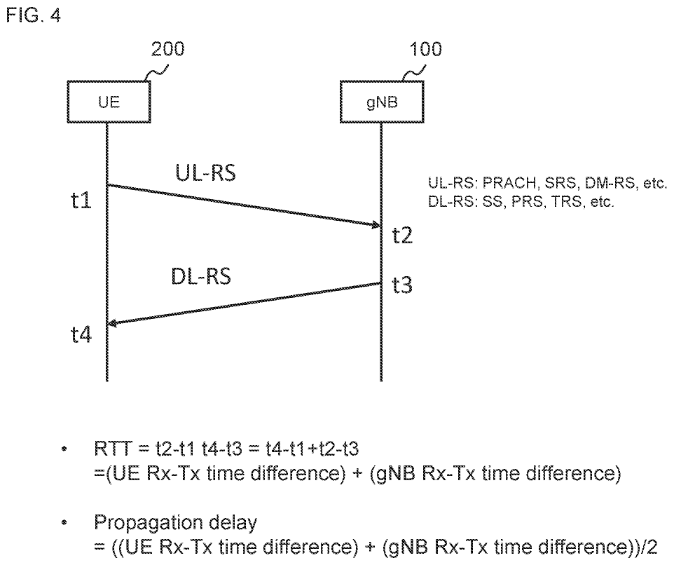

FIG. 4 shows an example of the calculation and reporting sequence of the UE Rx-Tx time difference and the gNB Rx-Tx time difference using UL-RS and DL-RS.

As shown in FIG. 4, the UE 200 transmits the UL-RS at time t1 (transmission timing), and the UL-RS is received by the gNB 100 at time t2 (reception timing).

The gNB 100 transmits the DL-RS to the UE 200 at time t3 (transmission timing), and the DL-RS is received by the UE 200 at time t4 (reception timing).

As described above, the types of UL-RS and DL-RS are not particularly limited. The UL-RS may include PRACH or the like, and the DL-RS may include SS or the like. The DL-RS may be transmitted first, and the UL-RS may be transmitted later.

The RTT and the propagation delay between UE 200 and gNB 100 may be expressed as follows.

RTT=t2−t1+t4−t3=t4−t1+t2−t3=(UE Rx-Tx time difference)+(gNB Rx-Tx time difference)

Propagation delay=((UE Rx-Tx time difference)+(gNB Rx-Tx time difference))/2

The UE Rx-Tx time difference (t4−t1) calculated by the UE 200 may be reported to the gNB 100 in any of the following ways.
Method 1: UE 200 periodically reports the UE Rx-Tx time difference.
Method 2: UE 200 reports the UE Rx-Tx time difference in response to a specific event.

In this case, the event may be defined, for example, as follows.
Event X: When the propagation delay between UE and gNB exceeds a predetermined threshold, a measurement report including the measurement result of UE Rx-Tx time difference is reported to the network.

The measurement report may be expressed as follows.
UE shall consider the entering condition for this event to be satisfied when PD-1 is filled;
UE shall consider the leaving condition for this event to be satisfied when PD-2 is filled;
Ms-Hys>Thresh+Offset PD-1 (entering condition)
Ms+Hys>Thresh+Offset PD-2 (leaving condition)

Ms may indicate a propagation delay between the UE and the gNB, and Hys may indicate a hysteresis parameter for the event.

Thresh is a reference threshold for the event and may be specified by MeasConfig (see 3 GPP TS 38.331) as a PropagationDelayThreshRef. Offset may indicate an offset value to the PropagationDelayThreshRef for obtaining the absolute threshold for the event. A time (timeToTrigger) may also be configured before the event is triggered.

Note that the UE 200 may add a reference system frame number (ReferenceSFN (System Frame Number)) when reporting the UE Rx-Tx time difference.

### (3.2) Operation Example 2

Next, an operation example of RTT based delay compensation will be described. Specifically, an example of a propagation delay compensation operation by a UE trigger and a propagation delay compensation operation by a gNB trigger will be described.

### (3.2.1) UE Trigger Propagation Delay Compensation

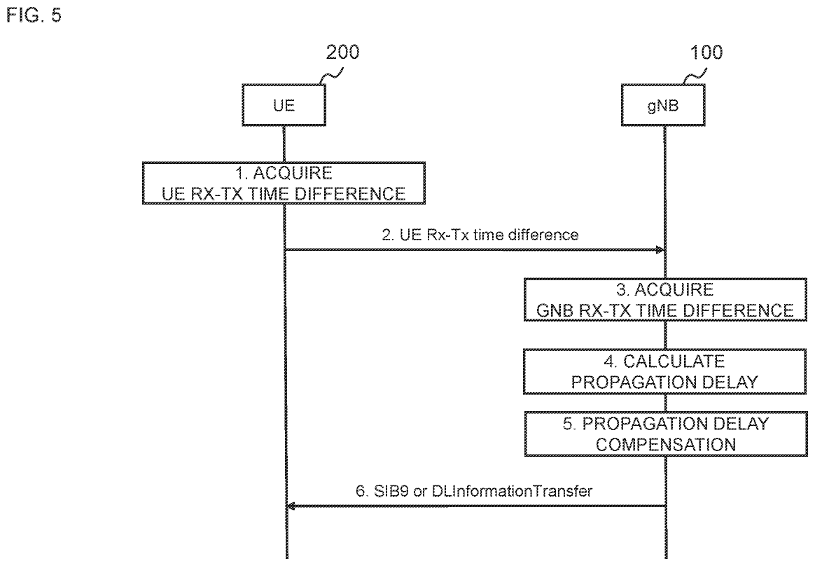

FIG. 5 shows an example of a schematic operation sequence of RTT based delay compensation by a UE trigger. As shown in FIG. 5, the UE 200 acquires the UE Rx-Tx time difference using UL-RS and DL-RS as described above, and reports the acquired UE Rx-Tx time difference to the gNB 100 (steps 1 and 2).

As described above, the gNB 100 obtains the gNB Rx-Tx time difference by using the UL-RS and the DL-RS, and calculates the propagation delay (steps 3 and 4).

The gNB 100 performs propagation delay compensation based on the calculated propagation delay (step 5). Specifically, the gNB 100 may adjust the time information for the NR system or TSN according to the propagation delay amount of the radio section.

In the case of RTT based delay compensation by such a UE trigger, the UE 200 may acquire the UE Rx-Tx time difference and transmit the acquired UE Rx-Tx time difference to the gNB 100 when the event described in the operation example 1 is satisfied (it may be called a UE event type trigger).

When the gNB 100 receives the UE Rx-Tx time difference from the UE 200, it may acquire the gNB Rx-Tx time difference. Here, “when received” means either immediately upon reception of the UE Rx-Tx time difference or within a predetermined time from reception.

The gNB 100 may calculate the propagation delay based on the UE Rx-Tx time difference and the gNB Rx-Tx time difference and perform the propagation delay compensation. Specifically, the gNB 100 may pre-compensate the propagation delay in the ReferenceTimeInfo and transmit the compensated time information to the UE 200 in the system information, specifically, the SIB 9 or DLInformationTransfer. The SIB 9 may be broadcast information, and the DLInformationTransfer may be unicast information.

Alternatively, the gNB 100 may send a propagation delay along with a ReferenceTimeInfo to the UE 200. In this case, the UE 200 may perform propagation delay compensation.

The UE Rx-Tx time difference from the UE 200 described above may be reported based on the UE 200 receiving an explicit instruction (For example, measurement request/report request) from the gNB 100. Alternatively, the UE 200 may request the transmission of the gNB Rx-Tx time difference by an explicit instruction to the gNB 100. In this case, the UE 200 may calculate the propagation delay after receiving the gNB Rx-Tx time difference and perform propagation delay compensation.

In the case of RTT based delay compensation by such a UE trigger, the UE 200 may periodically acquire the UE Rx-Tx time difference and transmit the acquired UE Rx-Tx time difference to the gNB 100 (it may be called a UE periodically trigger).

When the UE 200 periodically reports the measurement result of the UE Rx-Tx time difference to the gNB 100 and the gNB 100 receives the UE Rx-Tx time difference from the UE 200, the gNB Rx-Tx time difference may be obtained and the propagation delay may be calculated.

Alternatively, the gNB 100 may transmit the calculated propagation delay to the UE 200 using the SIB 9 or DLInformationTransfer, and the UE 200 may adjust the time information. Note that the gNB 100 may transmit the propagation delay to the UE 200 only when the propagation delay exceeds a predetermined threshold value, and the gNB 100 may pre-compensate the propagation delay.

### (3.2.2) Propagation Delay Compensation with gNB Triggers

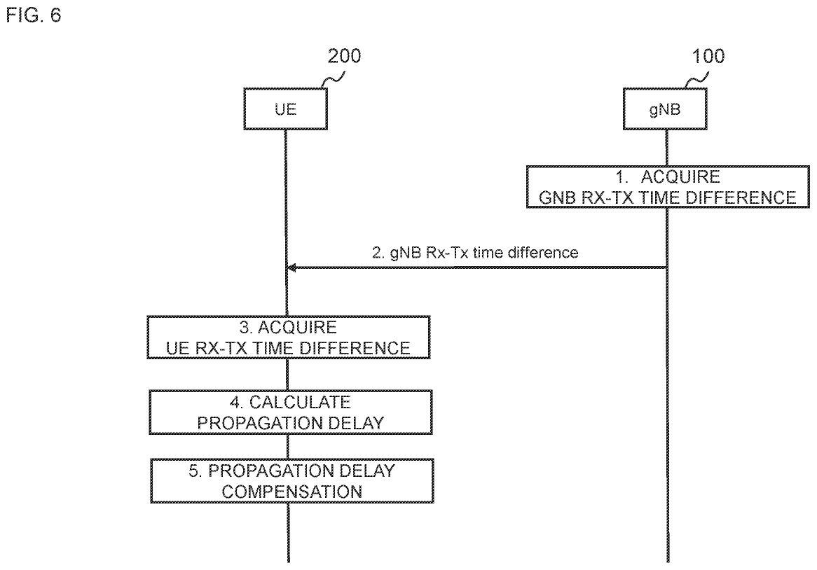

FIG. 6 shows an example of a schematic operation sequence of RTT based delay compensation by a gNB trigger. As shown in FIG. 6, the gNB 100 acquires the gNB Rx-Tx time difference using UL-RS and DL-RS as described above, and reports the acquired gNB Rx-Tx time difference to the UE 200 (steps 1 and 2).

As described above, the UE 200 obtains the UE Rx-Tx time difference using the UL-RS and the DL-RS, and calculates the propagation delay (steps 3 and 4).

The UE 200 performs propagation delay compensation based on the calculated propagation delay (step 5). Specifically, the UE 200 may adjust the time information for the NR system or TSN according to the propagation delay amount of the radio section.

In the case of RTT based delay compensation by such a gNB trigger, the gNB 100 measures the gNB Rx-Tx time difference, and when the gNB Rx-Tx time difference exceeds a predetermined threshold, the gNB Rx-Tx time difference may be transmitted to the UE 200 with the ReferenceTimeInfo using SIB 9 or DLInformationTransfer. The transmission of such a gNB Rx-Tx time difference may be interpreted as an indication of implicit propagation delay compensation to the UE 200. Alternatively, the gNB 100 may send an explicit propagation delay compensation indication to the UE 200.

The UE 200 may measure and acquire the UE Rx-Tx time difference in response to reception of the gNB Rx-Tx time difference. The UE 200 may calculate the propagation delay using the gNB Rx-Tx time difference and the UE Rx-Tx time difference to perform propagation delay compensation.

In the case of RTT based delay compensation by such a gNB trigger, the gNB 100 may periodically transmit the gNB Rx-Tx time difference together with the ReferenceTimeInfo to the UE 200. Such transmission of the gNB Rx-Tx time difference may also be interpreted as an indication of implicit propagation delay compensation to the UE 200. Alternatively, the gNB 100 may send an explicit propagation delay compensation indication to the UE 200.

The UE 200 may measure and acquire the UE Rx-Tx time difference in response to reception of the gNB Rx-Tx time difference. The UE 200 may calculate the propagation delay using the gNB Rx-Tx time difference and the UE Rx-Tx time difference to perform propagation delay compensation. Alternatively, the UE 200 may perform propagation delay compensation only when the propagation delay exceeds a predetermined threshold.

### (4) Operational Effects

According to the embodiment described above, the following effects are obtained. Specifically, when the UE Rx-Tx time difference exceeds a specified threshold, the UE 200 can transmit information indicating the UE Rx-Tx time difference (For example, measurement reports) to the gNB 100. When the UE 200 receives the gNB Rx-Tx time difference, it can also acquire the propagation delay with the gNB 100 based on the gNB Rx-Tx time difference and the UE Rx-Tx time difference.

When receiving the UE Rx-Tx time difference, the gNB 100 can acquire the propagation delay with the UE 200 based on the UE Rx-Tx time difference and the gNB Rx-Tx time difference.

Therefore, RTT-based delay compensation can be appropriately performed even when highly accurate synchronization is required for TSN. Thus, even when TSN is supported, highly accurate time information can be provided.

In this embodiment, the UE 200 may periodically receive the gNB Rx-Tx time difference from the gNB 100, or the gNB 100 may periodically receive the UE Rx-Tx time difference from the UE 200. Therefore, high-precision propagation delay compensation based on RTT can be easily continued. On the other hand, the UE Rx-Tx time difference or the gNB Rx-Tx time difference may be transmitted in response to a predetermined event as described above. In this case, timely propagation delay compensation according to the need can be easily realized.

### (5) Other Embodiments

Although the embodiment has been described above, it is obvious to those skilled in the art that various modifications and improvements are possible without being limited to the description of the embodiment.

For example, in the above-described embodiment, the measurement report is used to report the UE Rx-Tx time difference, but other methods, for example, upper layer (such as RRC) signaling or lower layer signaling (such as uplink control information (UCI)) may be used.

Similarly, methods other than SIB9 or DLInformationTransfer may be used to report the gNB Rx-Tx time difference.

Further, although the above-described embodiment assumes that radio communication system 10 is connected to the TSN, it does not have to be a network or application scenario in which high synchronization accuracy such as the TSN is required.

Further, the block configuration diagrams (FIGS. 2 and 3) used for the description of the above-described embodiment show blocks in units of functions. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that functions the transmission is called a transmission unit (transmitting unit) or a transmitter. As described above, there is no particular limitation on the method of implementation.

Further, the above-mentioned gNB 100 and UE 200 (the apparatus) may function as a computer that performs processing of the radio communication method of the present disclosure. FIG. 7 is a diagram showing an example of a hardware configuration of the gNB 100 and the UE 200. As shown in FIG. 7, the gNB 100 and UE 200 may be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device (see FIGS. 2 and 3) is realized by any hardware element of the computer device or a combination of the hardware elements.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001 operates, for example, an operating system to control the entire computer. Processor 1001 may comprise a central processing unit (CPU) including interfaces to peripheral devices, controllers, arithmetic units, registers, and the like.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. Memory 1002 may be referred to as a register, cache, main memory, or the like. The memory 1002 may store programs (program codes), software modules, and the like that are capable of executing the method according to one embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Devices such as the processor 1001 and the memory 1002 are connected by a bus 1007 for communicating information. The bus 1007 may be configured using a single bus or may be configured using different buses for each device.

Further, the device is configured to include hardware such as a microprocessor, a digital signal processor (Digital Signal Processor: DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Further, the notification of the information is not limited to the mode/embodiment described in the present disclosure, and other methods may be used. For example, notification of information may be performed by physical layer signaling (e.g., Downlink Control Information (DCI), Uplink Control Information (UCI), higher layer signaling (e.g., RRC signaling, Medium Access Control (MAC) signaling, broadcast information (Master Information Block (MIB), System Information Block (SIB)), other signals, or a combination thereof. The RRC signaling may also be referred to as an RRC message, for example, an RRC Connection Setup message, an RRC Connection Reconfiguration message, and the like.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, and the like of each aspect/embodiment described in the present disclosure may be changed in order as long as there is no contradiction. For example, the methods described in this disclosure use an exemplary sequence to present the elements of the various steps and are not limited to the particular sequence presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each of the aspects/embodiments described in the present disclosure may be used alone, in combination, or switched over in accordance with implementation. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channel and the symbol may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile body may be a vehicle (For example, cars, planes, etc.), an unmanned mobile body (Drones, self-driving cars, etc.), or a robot (manned or unmanned). At least one of a base station and a mobile station can be a device that does not necessarily move during the communication operation. For example, at least one of a base station and a mobile station may be an Internet of Things (IoT) device such as a sensor.

The base station in the present disclosure may be read as a mobile station (user terminal). For example, each aspect/embodiment of the present disclosure may be applied to a configuration in which communication between a base station and a mobile station is replaced with communication between a plurality of mobile stations (For example, it may be called Device-to-Device (D2D), Vehicle-to-Everything (V2X), etc.). In this case, the mobile station may have the function of the base station. In addition, words such as “up” and “down” may be replaced with words corresponding to communication between terminals (For example, “side”.). For example, terms an uplink channel, a downlink channel, or the like may be read as a side channel.

Similarly, the mobile station in the present disclosure may be read as a base station. In this case, the base station may have the function of the mobile station. A radio frame may be composed of one or more frames in the time domain. Each frame or frames in the time domain may be referred to as a subframe. A subframe may be further configured by one or more slots in the time domain. The subframe may be a fixed time length (For example, 1 ms) independent of the numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. PDSCH (or PUSCH) transmitted in time units greater than the minislot may be referred to as PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the sub-frame and TTI may be a sub-frame (1 ms) in the existing LTE, a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. The number of slots (minislot number) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain. The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by an index of the RB based on the common reference point of the carrier. PRB may be defined in BWP and numbered within that BWP.

BWP may include UL BWP (UL BWP) and DL BWP (DL BWP). One or a plurality of BWPs may be set in one carrier for the UE.

At least one of the configured BWPs may be active, and the UE may not expect to send and receive certain signals/channels outside the active BWP. Note that “cell”, “carrier”, and the like in this disclosure may be read as “BWP”.

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

The “means” in the configuration of each apparatus may be replaced with “unit”, “circuit”, “device”, and the like.

Any reference to an element using a designation such as “first”, “second”, and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining” and “determining” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. That is, “judgment” or “decision” may include regarding some action as “judgment” or “decision”. Moreover, “judgment (decision)” may be read as “assuming”, “expecting”, “considering”, and the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 radio communication system
20 NG-RAN
25 TSC GM
30 5GC
35 UPF
40 IoT Devices
100 gNB
110 radio communication unit
120 reference signal processing unit
130 time management unit
140 control unit
200 UE
210 radio communication unit
220 reference signal processing unit
230 time information processing unit
240 control unit
1001 processor
1002 memory
1003 storage
1004 communication device
1005 input device
1006 output device
1007 bus

1. A terminal comprising:
a control unit that acquires a time difference between a transmission timing of a first signal and a reception timing of a second signal; and
a transmission unit that, when the time difference exceeds a defined threshold value, transmits time difference information indicating the time difference to a radio base station.

2. A radio base station comprising:
a reception unit that receives time difference information indicating a first time difference between a transmission timing of a first signal and a reception timing of a second signal at a terminal;
a control unit that, when the time difference information is received, acquires a propagation delay with the terminal based on the first time difference and a second time difference between a reception timing of the first signal and a transmission timing of the second signal.

3. The radio base station according to claim 2, wherein the reception unit periodically receives the time difference information.

4. A terminal comprising:
a reception unit that receives time difference information indicating a first time difference between a reception timing of a first signal and a transmission timing of a second signal in a radio base station; and
a control unit that, when the time difference information is received, acquires a propagation delay with the radio base station based on the first time difference and a second time difference between a transmission timing of the first signal and a reception timing of the second signal.

5. The terminal according to claim 4, wherein the reception unit periodically receives the time difference information.
